(19) United States
(12) Patent Application Publication
(10) Pub. No.: US 2024/0396235 A1
(43) Pub. Date: Nov. 28, 2024

(54) Electrical Connector and Connector Assembly

(71) Applicant: Tyco Electronics (Shanghai) Co., Ltd., Shanghai (CN)

(72) Inventors: Yuchen Yang, Shanghai (CN); Tommy Qian, Shanghai (CN)

(73) Assignee: Tyco Electronics (Shanghai) Co., Ltd., Shanghai (CN)

(21) Appl. No.: 18/672,586

(22) Filed: May 23, 2024

(30) Foreign Application Priority Data
May 26, 2023 (CN) 202321313591.9

(51) Int. Cl. H01R 4/34; H01R 4/70; H01R 13/53

(52) U.S. Cl. CPC H01R 4/34; H01R 4/70; H01R 13/53

(57) ABSTRACT

An electrical connector includes a first connection terminal and an insulation housing. The first connection terminal has a first end and a second end opposite the first end. The insulation housing has a first housing portion and a second housing portion. The first housing portion extends in a first direction and defines a terminal accommodation space. The first end of the first connection terminal is installed in the terminal accommodation space. The second housing portion extends from a side of the first housing portion and defines an insertion passage communicated with the terminal accommodation space. The insertion passage has an insertion port. The insertion port or the insertion passage is sized to prevent a finger from contacting the first connection terminal positioned in the terminal accommodation space through the insertion port or the insertion passage.

### CROSS-REFERENCE TO RELATED APPLICATION

This application claims the benefit of the filing date under 35 U.S.C. § 119 (a)-(d) of Chinese Patent Application No. 202321313591.9, filed on May 26, 2023.

### FIELD OF THE DISCLOSURE

Embodiments of the present disclosure relate to an electrical connector and a connector assembly.

### BACKGROUND

An electrical connector is usually used to create electrical connections between various electronic elements or devices, and a high-voltage connector is mainly used in vehicles, charging facilities, industrial equipment, medical equipment, etc. For example, with the development of electric or hybrid vehicles, their connection requirements are becoming increasingly diverse, such as charging of a battery of the electric vehicle or high voltage connection of the battery to an electric motor. The connection must provide a safe and reliable high voltage/high current connection between a power battery, a power distribution unit, an inverter, the electric motor, a charger, or the like of the vehicle.

A connection system of the electric vehicle needs to be able to carry very high current levels, especially during high-power charging or peak acceleration. The electric vehicle uses high-voltage connectors to achieve transmission of 60V or higher voltage levels and 10 A-300 A or even higher current levels. In high-voltage applications, the electrical connector, especially a board end connector, such as those electrically connected to power sources such as batteries, are required to have finger protection to avoid the risk of electric shock. In conventional high-voltage connectors, in order to achieve the finger protection function, a connection terminal with a special structure or configuration is usually used, or an additional part or component is added, or a specific process (such as embedded molding process) is used to manufacture the connector, resulting in increased costs.

In addition, a physical space within the vehicle itself is limited, so those electrical connections also need to be optimized in terms of compactness, weight, geometric flexibility, and cost. Due to the limited installation space within the vehicle, the height of the connector product and the avoidance space below the wiring harness are challenged. Some conventional quick plug connector structures do not meet the installation height requirements. A conventional screw connector structure may be customized to meet the height requirements, but it will interfere with an internal structure of the vehicle and the cost is high.

### SUMMARY

An electrical connector includes a first connection terminal and an insulation housing. The first connection terminal has a first end and a second end opposite the first end. The insulation housing has a first housing portion and a second housing portion. The first housing portion extends in a first direction and defines a terminal accommodation space. The first end of the first connection terminal is installed in the terminal accommodation space. The second housing portion extends from a side of the first housing portion and defines an insertion passage communicated with the terminal accommodation space. The insertion passage has an insertion port. The insertion port or the insertion passage is sized to prevent a finger from contacting the first connection terminal positioned in the terminal accommodation space through the insertion port or the insertion passage.

### BRIEF DESCRIPTION OF THE DRAWINGS

Features and advantages of embodiments of the present disclosure will be apparent from the following description made in conjunction with the accompanying drawings, in which:

FIG. 1 is a perspective view schematically illustrating an overall configuration of a connector assembly according to an exemplary embodiment of the present disclosure;

FIG. 2 is a perspective view schematically illustrating an insertion or separation process between an electrical connector and a mating connector of a connector assembly according to an exemplary embodiment of the present disclosure;

FIG. 3 is a perspective end view schematically illustrating a structure of an electrical connector according to an exemplary embodiment of the present disclosure;

FIG. 4 is a schematic cross-sectional view of the electrical connector taken along line A-A in FIG. 3 according to an exemplary embodiment of the present disclosure;

FIG. 5 is a perspective view schematically illustrating a structure of a mating connector according to an exemplary embodiment of the present disclosure;

FIG. 6 is a schematic sectional view of the connector assembly taken along line B-B in FIG. 1 according to an exemplary embodiment of the present disclosure; and

FIG. 7 is a perspective view schematically illustrating a structure of a second connection terminal of a mating connector according to an exemplary embodiment of the present disclosure.

### DETAILED DESCRIPTION OF EXEMPLARY EMBODIMENTS

Embodiments of the present disclosure will be described hereinafter in detail taken in conjunction with the accompanying drawings. In the description, the same or similar parts are indicated by the same or similar reference numerals. The description of each of the embodiments of the present disclosure hereinafter with reference to the accompanying drawings is intended to explain the general inventive concept of the present disclosure and should not be construed as a limitation on the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

In the following detailed description, the directional term, such as “front”, “back”, “up”, “down”, “top”, “bottom”, “left”, “right”, “upper” and “lower”, “inside”, “outside”, etc., may be defined by the drawings, but the shape and the location of the component is not limited by the term and can be adjusted according to actual applications.

In addition, the term used herein is for the purpose of describing example embodiments only and is not intended to limit and or restrict the present disclosure. The singular forms “a,” “an,” “said” and “the” are intended to include the plural forms as well, unless the context clearly indicates otherwise. In the present disclosure, the terms “including,” “having,” and the like are used to specify features, numbers, operations, elements, components, or combinations thereof, but do not preclude the presence or addition of one or more of the features, elements, operations, elements, components, or combinations thereof.

Although the terms “first,” “second,” etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

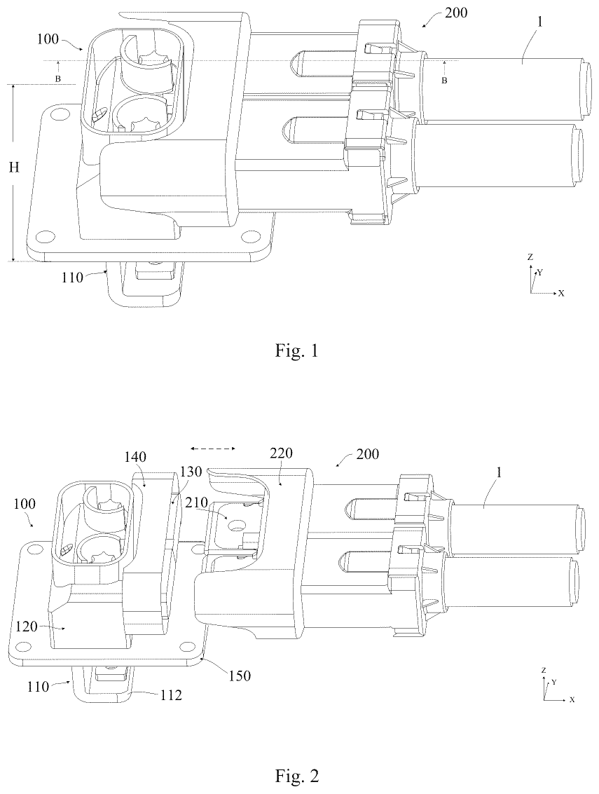

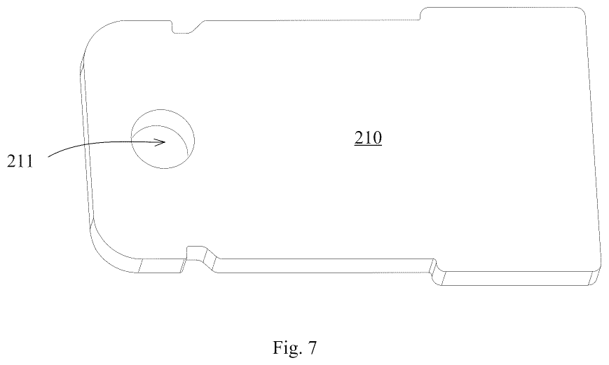

As shown in FIGS. 1-7, according to an exemplary embodiment of the present disclosure, there are provided an electrical connector and a connector assembly including the electrical connector for creating electrical connections between various types of electronic elements or devices. As an example, the electrical connector or connector assembly provided by the present disclosure may be used as a high-voltage electrical connector in fields such as electric vehicles, hybrid vehicles, electric industrial equipment, medical equipment, charging facilities, etc., for example, to provide safe and reliable high-voltage/high current connections between electrical devices such as a power battery, a power distribution unit, a power control unit, an inverter, an electric motor, a charger or the like of the vehicle.

In the illustrated exemplary embodiments, the connector assembly includes an electrical connector 100 and a mating connector 200 which can be engaged and mated with each other. Illustratively, in the following description and drawings, the electrical connector 100 being a socket connector adapted to be fixed and the mating connector 200 being a plug connector adapted to be connected with a cable 1 will be described as an example, but the present disclosure is not limited to this.

As shown in FIGS. 1-4 and 6, the electrical connector 100 includes a first connection terminal 110, and a housing which may be made of insulation materials, such as plastic, one or more first connection terminals 110 being at least partially installed in the housing and may be used for power or signal transmission. The first connection terminal 110 has a first end 111 and an opposite second end 112, as described below. The first end 111 serves as a mating end for electrical connection (such as electrical contact) with a second connection terminal 210 of the mating connector 200, and the second end 112 may serve as an installation end for installation or electrical connection to the electrical device or its internal electronic element (such as a copper bar, a cable, a battery, a circuit board, etc.).

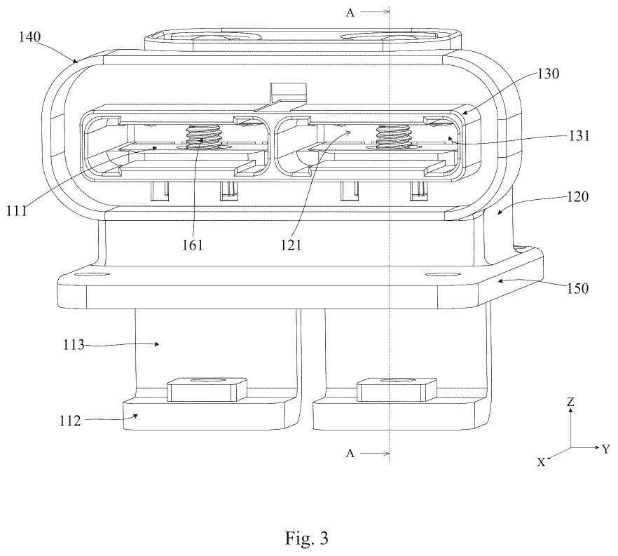

In the illustrated embodiments, the housing of the electrical connector 100 includes a first housing portion 120, which extends in a first direction (e.g., in the Z direction in the figures) and defines a terminal accommodation space 121, as shown in FIGS. 2 and 3. The first end 111 of the first connection terminal 110 is installed within the terminal accommodation space 121. As an example, the first housing portion 120 may have a roughly cylindrical profile; and an installation height of the electrical connector on the electrical device or installation panel is related to the size of the first housing portion 120 extending in the first direction Z, so the size of the first housing portion 120 extending in the first direction Z could be reasonably designed to achieve the electrical connector with a compact profile and meet the installation space requirements of the electrical connector in specific applications.

According to exemplary embodiments of the present disclosure, as shown in FIGS. 2-4 and 6, the housing of the electrical connector 100 further includes a second housing portion 130. In some embodiments, the second housing portion 130 extends from one side (e.g., an outer wall) of the first housing portion 120 in a second direction (e.g., the X direction in the figures) that is different from the first direction Z, so that the housing of the electrical connector 100 as a whole may have a bent or elbow structure to be adapted for limited installation space (e.g., with limited height, lateral size or orientation). In some examples, an angle greater than 0 degree and less than or equal to 90 degrees may be formed between the second direction and the first direction, or between the second housing portion 130 and the first housing portion 120. For example, the second direction is perpendicular to the first direction, that is, the second housing portion 130 extends perpendicular to the first housing portion 120, so that a 90-degree or right-angle connector may be formed. However, the present disclosure is not limited to this. In other embodiments, the electrical connector or its housing may also adopt a linear structure, such as a linear socket, depending on the specific application or installation space requirements.

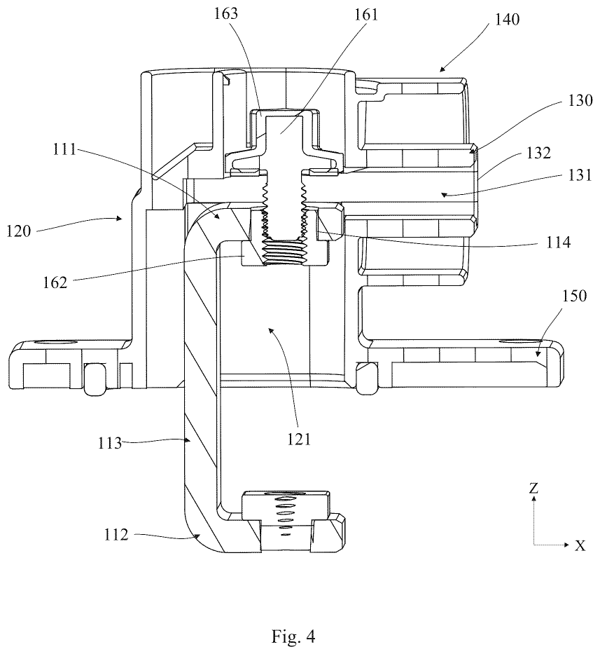

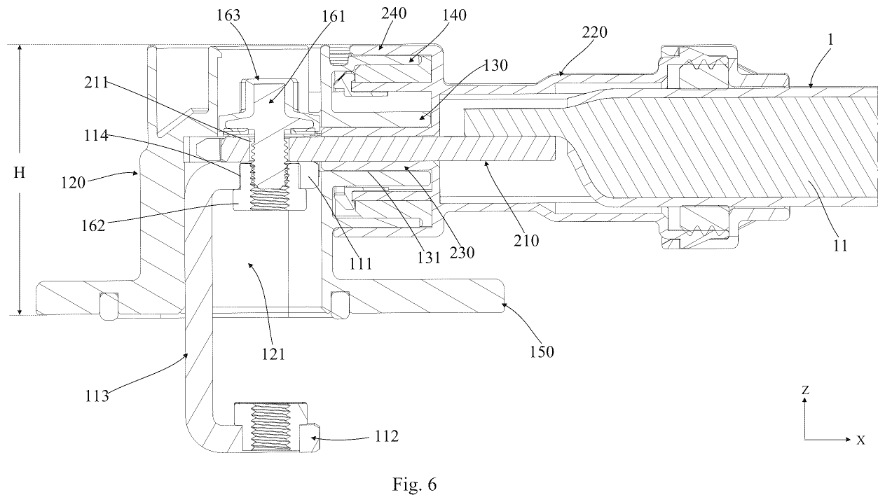

The second housing portion 130 defines an insertion passage 131, as shown in FIG. 4, which is communicated with the terminal accommodation space 121 of the first housing portion 120, thereby allowing one end of the second connection terminal 210 of the mating connector 200 to be inserted into the terminal accommodation space 121 through the insertion passage 131 to make electrical contact with the first end 111 of the first connection terminal 110 positioned in the terminal accommodation space 121, as shown in FIG. 6. For example, the mating connector 200 or its second connection terminal 210 may be mated with the electrical connector 100 in the second direction as the insertion direction.

In some embodiments, the second housing portion 130 has a cylindrical shape defining the insertion passage 131, such as a rectangular cylindrical or circular cylindrical shape, which is configured and arranged to allow the second connection terminal 210 to be inserted the insertion passage. The insertion passage 131 has an insertion port 132 positioned away from the terminal accommodation space 121, as shown in FIG. 4, so that at least the first end of the first connection terminal 110 positioned in the terminal accommodation space 121 is visible when viewed from the insertion port 132. The second connection terminal 210 (one end of the second connection terminal 210) of the mating connector 200 is inserted into the insertion passage 131 through the insertion port 132 and guided to the first end 111 of the first connection terminal 110 positioned in the terminal accommodation space 121.

In exemplary embodiments of the present disclosure, the insertion passage 131 or the insertion port 132 of the second housing portion 130 is sized to prevent a finger or fingers of the user from entering the insertion passage 131 and coming into contact with the first connection terminal 110 positioned in the terminal accommodation space 121 (e.g., during operation, when inserting or separating the mating connector), so that the finger(s) cannot touch the first connection terminal 110 through the insertion port 132 or the insertion passage 131, thereby providing finger protection or anti-touch function at the side of the electrical connector 100. Safety is thereby improved without the need for additional parts (such as additional components to cover or protect the connection terminals) or additional costs.

For example, the size of the insertion passage 131 and/or the insertion port 132 of the second housing portion 130 in one dimension (e.g., a dimension or direction perpendicular to the insertion direction, for example the first direction) may be smaller than the size (such as width or thickness) of the finger in a direction perpendicular to a length of the finger, thereby preventing the finger(s) of the user from unintentionally entering the insertion passage/the terminal accommodation space and touching the connection terminal, effectively avoiding the risk of electric shock. It will be understood that the present disclosure is not limited to this, and for example, in the case where the first and second connection terminals are stacked and in contact with each other in a third direction Y perpendicular to the first and second directions, the size of the insertion passage 131 and/or the insertion port 132 of the second housing portion 130 in the third direction may be smaller than the size (such as width or thickness) of the finger in the direction perpendicular to the length of the finger. In other examples, the length of the insertion passage extending in the second direction may be greater than the length of the finger.

The mating connector 200 includes a shell 220, and the second connection terminal 210 is partially arranged within the shell 220 and adapted to be connected to the cable 1 at the other end, such as being electrically connected to a core 11 of the cable 1, as shown in FIGS. 2, 5, and 6. In some examples, the mating connector 200 may be a linear plug, and its shell 220 may extend, for example, in the second direction, so that the extension direction of the mating connector 200 (and the extension direction of the cable 1 connected at the other end) is consistent with the insertion direction of the mating connector 200 inserted into the electrical connector 100, reducing the space required for installation. In other examples, the mating connector 200 may also have a right-angle shell or be a right-angle plug to be adapted for different installation requirements.

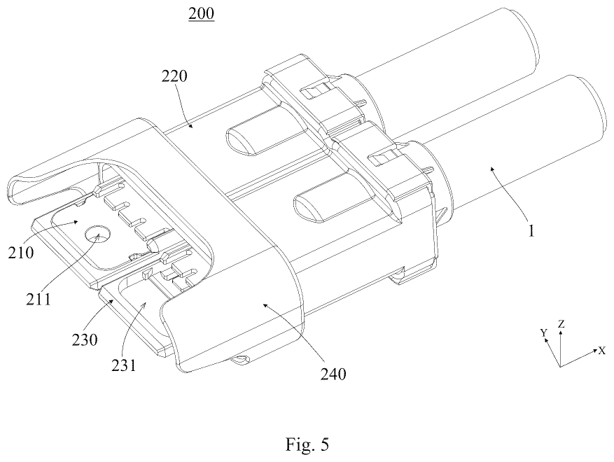

In optional embodiments, as shown in FIGS. 5-6, the mating connector 200 may further include a terminal holder 230, which is adapted to hold the second connection terminal 210. For example, the terminal holder 230 may extend from the shell 220 in the second direction and be inserted into the insertion passage 131 of the second housing portion 130 during assembling, so that the one end of the second connection terminal 210 held on the terminal holder 230 may enter the terminal accommodation space 121 of the first housing portion 120 to make electrical contact with the first end 111 of the first connection terminal 110. As an example, the terminal holder 230 may be a frame with a hollow portion 231, and the second connection terminal 210 may be held in the hollow portion 231 of the terminal holder 230 in a snap-fit manner, for example.

As shown in FIGS. 2, 3 and 6, the electrical connector 100 may further include a third housing portion 140, which extends circumferentially around the second housing portion 130 from the first housing portion 120. A portion of the shell of the inserted mating connector 200 and/or a seal may be accommodated in a space between the second housing portion 130 and the third housing portion 140. As shown in the figures, the mating connector 200 or its shell 220 may include an extension portion 240, shown in FIG. 5, which may at least partially surround the terminal holder 230 and the second connection terminal 210 held therein. In the assembled state, the extension portion 240 may be positioned outside of the third housing portion 140 or in the space between the second housing portion 130 and the third housing portion 140 to cover at least the insertion port 131 of the insertion passage 130, so that the terminals therein cannot be touched from the outside of the shell after assembling.

The electrical connector 100 may also include a fastening assembly, by which the first connection terminal 110 or its first end 111 may be detachably fixed within the terminal accommodation space 121. In some examples, as shown in FIG. 6, the fastening assembly may also keep the first end 111 of the first connection terminal 110 in a fixed contact with the one end of the inserted second connection terminal 210. The first end 111 of the first connection terminal 110 may have at least a plate-shaped portion to make surface contact with the one end of the second connection terminal 210.

In some embodiments, as shown in FIGS. 4 and 6, the fastening assembly includes a fastening screw 161 and a nut 162. In the assembled state, the fastening screw 161 and the nut 162 are arranged on opposite sides of the first end 111 of the first connection terminal 110 in the first direction respectively; for example, the fastening screw 161 passes through a second through-hole 211 (see FIGS. 2 and 5-7) formed in the one end of the second connection terminal 210 and a first through-hole 114 formed in the first end 111 of the first connection terminal 110 to be engaged with the nut 162 (e.g., through threaded connection), so that the one end of the second connection terminal 210 and the first end 111 of the first connection terminal 110 are stacked and squeezed between the nut 162 and a head of the fastening screw 161 (e.g., in the first direction) to maintain a firm contact therebetween.

During the assembling process, the nut 162 may be partially positioned in the first through-hole 114 in such a manner that its head abuts against a surface of the first end 111, and the fastening screw 161 may be inserted sequentially through the second through-hole 211 and the first through-hole 114 from a hole of the first housing portion 120 communicated with the terminal accommodation space 121 (see FIGS. 1-4 and 6) to be engaged with the nut 162 in such a manner that its head directly or indirectly abuts against the one end of the second connection terminal 210. In the illustrated embodiments, a separate nut 162 is provided, a portion of which (such as a main body with a diameter smaller than that of the head) may be positioned in the first through-hole 114 of the first end 111; however, the present disclosure is not limited to this. In other embodiments, the first end 111 of the first connection terminal 110 may be integrally formed with a nut or threaded structure for engagement with the fastening screw 161.

In some examples, as shown in FIGS. 4 and 6, the fastening assembly may also include an insulation cover 163, which covers at least the head of the fastening screw 161 to avoid the risk of electric shock of the user caused by accidental contact with the fastening screw 161.

As mentioned above, the electrical connector 100 is adapted to be installed or fixed to the electrical device. In the illustrated embodiments, the housing of the electrical connector 100 may further include a flange portion 150, shown in FIGS. 2-4 and 6, which is adapted to be installed onto an installation panel of the electrical device by a fastener. The flange portion 150 may extend outwardly (e.g., vertically) from a periphery of the first housing portion 120, forming a flat plate or other suitable shape for installation. After assembling, the second end 112 of the first connection terminal 110 is positioned on the other side of the flange portion 150 opposite to the first housing portion 120, to be positioned an outside of the terminal accommodation space 121, so as to easily connected with the electrical device or its internal electronic element. In some specific examples, in the first direction (the Z direction in the figures), the height from the flange portion 150 (i.e. its lower installation surface) to a top of the first housing portion 110 is less than or equal to an expected value (such as 46 mm or less), so that the total installation height of the housing of the electrical connector in the first direction or the installation height of the connector assembly protruding from the installation panel in the first direction is not greater than the expected value, so as to meet some current installation space requirements.

Although the above embodiments of the present disclosure have been shown and described, it would be appreciated by those skilled in the art that various changes or modifications may be made to these embodiments without departing from the principles and spirit of the disclosure, the scope of which is defined by the appended claims and their equivalents. It should be noted that, the terms such as “comprise”, “include”, “have” or the like as used herein don't exclude other elements or steps. In addition, any reference numerals in the claims should not be interpreted as the limitation to the scope of the present disclosure.

What is claimed is:

1. An electrical connector, comprising:
a first connection terminal having a first end and a second end opposite the first end; and
an insulation housing having a first housing portion and a second housing portion, the first housing portion extending in a first direction and defining a terminal accommodation space, the first end of the first connection terminal is installed in the terminal accommodation space, the second housing portion extends from a side of the first housing portion and defines an insertion passage communicated with the terminal accommodation space, the insertion passage has an insertion port, the insertion port or the insertion passage is sized to prevent a finger from contacting the first connection terminal positioned in the terminal accommodation space through the insertion port or the insertion passage.

2. The electrical connector of claim 1, wherein the first end of the first connection terminal is electrically connectable to a second connection terminal of a mating connector.

3. The electrical connector of claim 2, wherein an end of the second connection terminal passes through the insertion port and the insertion passage to be inserted into the terminal accommodation space to electrically contact the first connection terminal.

4. The electrical connector of claim 3, wherein the second housing portion extends in a second direction different from the first direction to allow the second connection terminal to be inserted into the terminal accommodation space in the second direction.

5. The electrical connector of claim 4, wherein an angle of greater than 0 degrees and less than or equal to 90 degrees is formed between the second direction and the first direction.

6. The electrical connector of claim 1, wherein the second housing portion has a cylindrical shape defining the insertion passage.

7. The electrical connector of claim 6, wherein the first end of the first connection terminal is visible when viewed from the insertion port.

8. The electrical connector of claim 3, further comprising a fastening assembly fastening the first end of the first connection terminal in the terminal accommodation space.

9. The electrical connector of claim 8, wherein the fastening assembly keeps the first end of the first connection terminal in a fixed contact with the end of the second connection terminal.

10. The electrical connector of claim 9, wherein the first end of the first connection terminal has a first through-hole.

11. The electrical connector of claim 10, wherein the fastening assembly includes a fastening screw and a nut arranged on opposite sides of the first end of the first connection terminal in the first direction.

12. The electrical connector of claim 11, wherein the fastening screw passes through a second through-hole formed in the end of the second connection terminal and the first through-hole to be engaged with the nut.

13. The electrical connector of claim 12, wherein the end of the second connection terminal and the first end of the first connection terminal are stacked and squeezed between the nut and a head of the fastening screw.

14. The electrical connector of claim 13, wherein the first end of the first connection terminal has a plate-shaped portion making a surface contact with the end of the second connection terminal.

15. The electrical connector of claim 14, wherein the fastening assembly has an insulation cover covering the head of the fastening screw.

16. A connector assembly, comprising:
an electrical connector including a first connection terminal and an insulation housing, the first connection terminal has a first end and a second end opposite the first end, the insulation housing has a first housing portion and a second housing portion, the first housing portion extending in a first direction and defining a terminal accommodation space, the first end of the first connection terminal is installed in the terminal accommodation space, the second housing portion extends from a side of the first housing portion and defines an insertion passage communicated with the terminal accommodation space, the insertion passage has an insertion port, the insertion port or the insertion passage is sized to prevent a finger from contacting the first connection terminal positioned in the terminal accommodation space through the insertion port or the insertion passage; and
a mating connector inserted and engaged with the electrical connector in a second direction.

17. The connector assembly of claim 16, wherein the mating connector has a second connection terminal with an end passing through the insertion port and the insertion passage to be inserted into the terminal accommodation space to electrically contact the first connection terminal.

18. The connector assembly of claim 17, wherein the mating connector includes a shell extending in the second direction, the second connection terminal is partially arranged within the shell, the second connection terminal has another end connected with a cable.

19. The connector assembly of claim 16, wherein the electrical connector is a socket and the mating connector is a plug connector.

20. The connector assembly of claim 16, wherein the second direction is perpendicular to the first direction.
